(19) United States
(12) Patent Application Publication
(10) Pub. No.: US 2013/0146816 A1
(43) Pub. Date: Jun. 13, 2013

(54) ONE PART EPOXY RESIN INCLUDING ACRYLIC BLOCK COPOLYMER

(71) Applicants: Rong-Chang Liang, Cupertino, CA (US); Yuhao Sun, Fremont, CA (US); Chin-Jen Tseng, Fremont, CA (US)

(72) Inventors: Rong-Chang Liang, Cupertino, CA (US); Yuhao Sun, Fremont, CA (US); Chin-Jen Tseng, Fremont, CA (US)

(73) Assignee: Trillion Science Inc., Fremont, CA (US)

(21) Appl. No.: 13/761,703

(22) Filed: Feb. 7, 2013

Related U.S. Application Data
(63) Continuation-in-part of application No. 12/762,623, filed on Apr. 19, 2010.

(51) Int. Cl. C09J 163/00

(52) U.S. Cl. CPC C09J 163/00
USPC 252/500; 523/434

(57) ABSTRACT

An adhesive composition comprising a phenoxy resin, a latent hardener, an acrylic block co-polymer dispersant and a weak solvent wherein the dispersant enables the phenoxy resin to be dispersed in a weak solvent that does not attack the latent hardener thereby providing a composition with good shelf life. The compositions are useful in making anisotropic conductive films.

### RELATED APPLICATIONS

This is a continuation-in-part of U.S. application Ser. No. 12/762,623 filed Apr. 19, 2010.

### BACKGROUND OF THE INVENTION

1. Field of the Invention

The invention relates to epoxy adhesive or molding compound compositions suitable for connecting, assembling, encapsulating or packaging electronic devices particularly for display, circuit board, flip chip and other semiconductor devices containing a low profile additive. This invention particularly relates to one-part epoxy compositions containing an acrylic block copolymer, that can be used as a dispersant to provide a stable dispersion of phenoxy resin in weak solvents which have a solubility parameter less than 9.5 and, more particularly less than about 9.0 and which are compatible with microencapsulated latent hardeners (i.e., they do not attack or soften the shell wall). More specifically, application of this epoxy relates to adhesives for an anisotropic conductive film (ACF) to adhesively bond two electric terminals with good electroconductivity. The acrylic block copolymer may also provide the function of a low profile additive.

2. Description of the Related Art

Epoxy systems, one part epoxy systems in particular, have the advantages of convenient applications as adhesives or molding compounds for connecting, assembling, encapsulating or packaging electronic devices, for adhesive or molding compound applications, epoxies are considered to be superior to the thermoplastic adhesives because of the process-ability of the uncured composition and the heat resistance of the cured products. Furthermore, among the epoxy applications, the one-part epoxy systems are in general more preferred than the two-part systems for most of the molding compounds and pre-coated products including anisotropic conductive adhesive films (ACFs or ACAFs). This is because the one-part systems are much more user friendly between these two systems.

Although epoxy adhesive compositions exhibit a number of advantages including good strength and high adhesion, they suffer certain drawbacks. In particular, they often employ polar solvents having a solubility parameter in the range of greater than 9.5 to 11.5 to dissolve the high molecular weight phenoxy resins, thermoplastic polyethers based on bisphenol-A and epichlorohydrin with bisphenol-A terminal groups, which are often used as the binder particularly in the ACF applications. In some cases these solvents have a tendency to attack the latent hardener shell wall and reduce the stability or shelf life of the adhesive composition. Epoxy adhesives also shrink upon curing and this shrinkage causes internal stress that can cause the formation of micro-voids or micro-cracks. This shrinkage is associated with two occurrences: (1) thermal contraction when the heated bonding element is removed and the compound cools, and (2) volume shrinkage resulting from the tight network that is developed upon physical and chemical crosslinking of the compound. These cracks and voids reduce the mechanical strength of the adhesive bond and they also make the compound susceptible to moisture such that the bonded electronic component may fail when subjected to high temperature and high humidity aging (HHHT).

### SUMMARY OF THE INVENTION

The one-part epoxy coating fluid typically includes an uncured phenoxy resin component, a latent hardener, a multifunctional epoxide, an acrylic block copolymer dispersant and a weak solvent having a solubility parameter less than 9.5 and, more particularly, less than about 9.0. In one embodiment the acrylic block copolymer includes at least one flexible mid block and, more particularly, an elastomeric mid block; and at least one rigid block that renders the copolymer compatible with the uncured epoxy resin. In one embodiment the latent hardener is a microencapsulated hardener, e.g., a latent hardener of the Novacure variety, for example, Novacure HXA-3922, 3932, 3641 and 3742 available from Asahi Kasei KK. Novacure latent hardeners from Asahi Kasei are microcapsules of highly reactive curing agents such as imidazoles and their epoxide adducts encapsulated by e.g. a polyurethane or polyurea shell or matrix, and dispersed in multifunctional epoxides such as bisphenol F diglycidyl ether, or mixtures thereof with other epoxides.

The improved epoxy composition as will be further described below in one embodiment may be implemented in an exemplary embodiment as conductive coating or adhesive for an anisotropic conductive film (ACF) and, in a particular embodiment in the ACF described in U.S. Published Application 2006/0280912 to Liang et al. The ACF includes a plurality of conductive particles disposed at predetermined locations in or on an adhesive layer on a release substrate. The improved epoxy composition may further be employed as a conductive coating or adhesive for connecting, packaging or encapsulating electronic components in another exemplary embodiment similar to the application of the adhesive described in U.S. Published Application 2008/0090943. The disclosures made in the aforementioned published patent applications are hereby incorporated by reference in this patent application. In another embodiment, the film without the conductive particles may be used in various applications such as in semiconductor packaging or in LED assemble.

In one embodiment, the use of the block copolymers, as disclosed herein, as dispersants enables a uniform coating process and results in a stable, long shelf life coated films containing a latent hardener such as imidazole microcapsules. The block copolymers act as dispersants for the phenoxy resins in weak solvents (e.g., solvents having a solubility parameter less than 9.5 and more particularly less than about 9.0). These weak solvents have reduced tendency to attack the latent hardeners during the compounding and coating processes and thereby provide a more shelf stable adhesive composition both before and after the coating is dried.

### Typical Epoxy Adhesives and Molding Compounds

The epoxy resin component includes at least one epoxy resin that has two or more epoxy groups in a single molecule. A multifunctional epoxide is a di-, tri-, tetra-, penta-, hexa- or other polyfunctional epoxide. Multifunctional epoxides having three or more epoxide groups are useful as cross-linkers in the composition. Improved thermomechanical properties of cured epoxy adhesives or coatings may be achieved by incorporating small amounts of about 1 to 10% of a crosslinking epoxide into the composition. However, too high a concentration of a crosslinker may provide a product that is too brittle. The latent hardener containing the curing agent initiates and/or accelerates the reaction by either catalyzing and/or taking part in the reaction. Preferably, the hardener component and the other epoxy adhesive components are selected such that the epoxy adhesive is very stable at the storage conditions but cures rapidly at the bonding temperature. Reviews of epoxy crosslinking systems may be found in, for example, J. K. Fink, “Reactive Polymers, Fundamentals and Applications,” William Andrew Publishing, NY (2005); J. A. Brydson, “Plastic Materials,” Ch. 26, 7th ed., Butterworth-Heinemann (1999); C. D. Wright and J. M. Muggee in S. R. Hartshorn, ed., “Structure Adhesives,” Ch. 3, Plenum Press, NY (1986); and H. Lee, “The Epoxy Resin Handbook,” McGraw-Hill, Inc., NY (1981).

Typical examples of multifunctional epoxides or epoxy resins used in adhesives or molding compounds include polyglycidyl ethers of polyhydric phenols such as bisphenol epoxy resins derived from epichlorohydrin and bisphenol A or bisphenol F, and epoxy novolak resins derived from epichlorohydrin and phenol novolak or cresol novolak resins (e.g., Epon 161 and Epon 165 available from available from Hexion Specialty Chemicals). Other examples of mulifunctional epoxides or epoxy resins include polyglycidyl esters of polycarboxylic acids, alicyclic epoxy compounds, polyglycidyl ethers of polyhydric alcohols, and polyglycidyl compounds of polyvalent amines. Specific examples include bisphenol F epoxy resin such as EPOTOHTO YDF-8170 from Tohto Kasei Co., Ltd. and YL 983U from JAPAN EPDXY RESINS Co., Ltd; and bisphenol A epoxy resins such as DER-332 from The Dow Chemical Company, and YL 980.from JAPAN EPDXY RESINS Co., Ltd.; and alicyclic epoxy resin such as CELLOXIDE 2021 from DAICEL CHEMICAL INDUSTRIES, Ltd. These compounds may be partly modified in the structure, e.g., with urethane, nitrile rubber or silicone. Additional examples of suitable epoxides may be found in, for example: J. K. Fink, “Reactive Polymers, Fundamentals and Applications,” William Andrew Publishing, NY (2005); J. A. Brydson, “Plastic Materials,” Ch. 26, 7th ed., Butterworth-Heinemann (1999); H. Lee, “The Epoxy Resin Handbook,” McGraw-Hill, Inc., NY (1981); and C. D. Wright and J. M. Muggee in S. R. Hartshorn, ed., “Structure Adhesives,” Ch. 3, Plenum Press, NY (1986).

The adhesive may also contain a binder or thickener to improve the melt flow charateristics and the structure integrity during high speed ACF bonding processes. Linear polymers or copolymers of bisphenol A and diglycidyl ether and other phenoxy resins are often employed as the binder in ACF applications. In one embodiment, Paphen phenoxy resin (PKHH) from Phenoxy Specialties or PKFE from Inchem Corp. is used as the binder or thickener. This resin series typically has a solubility parameter of about 10.68 and is available from companies such as InChem Corp, Rock Hill, S.C. In one embodiment these resins have a molecular weight of about 2,000 to 1,000,000, preferably from about 20,000 to 100,000 and include resins such as PKFE (Mw=60000, melt index<4 g/10 min at 200 C), PKHJ (Mw=57000, MI<4) and PKHH (Mw=52000, MI=4) are particularly useful in ACF applications for their ability to maintain the structure integrity of the adhesive during bonding probably because of their low melt flow at high temperature (170-210° C.) and high compatibility with multifunctional epoxides. The cured adhesives are also of high modulus and better reliability at high temperature applications. The binder may be used in amounts of about 10 to 50 wt. % and more particularly about 20 to 40 wt. %. In one embodiment, the epoxy composition comprises epoxidized Epon 161 (phenolic novolac resin) and Epon 165 (epoxidized cresol novolac resin), both from Momentive Specialty Chemicals Inc., Ohio, bisphenol A diglycidyl ether and bisphenol F diglycidyl ether from Sigma-Adrich, and PKHH from InChem Corp. In another embodiment, the composition comprises Epon 161, Epon 165, Bisphenol F and PKFE. In still another embodiment, the composition comprises Epalloy 8330 (epoxidized phenolic novolac resin) from CVC Thermoset Specialties, NJ, bisphenol F diglycidyl ether, and glycerol triglycidyl ether from Sigma-Aldrich.

Examples of epoxy compositions (not including solvents and the epoxides from the hardener composition, if there is any) used herein are provided below.

Epoxy Composition 1

| | Parts |
|---|---|
| Ingredient | (dry) |
| Bis-A epoxy (YL980U) | 5.35 |
| Bis-F epoxy (YL983U) | 16.37 |
| Epon 161 | 6.22 |
| Epon 165 | 3.11 |
| PKHH | 22.89 |

Epoxy Composition 2

| | Parts |
|---|---|
| Ingredient | (dry) |
| Bis-A epoxy (YL980U) | 4.92 |
| Bis-F epoxy (YL983U) | 15.04 |
| Epon 161 | 5.72 |
| Epon 165 | 2.86 |
| PKHH | 24.14 |

Epoxy Composition 3

| | Parts |
|---|---|
| Ingredient | (dry) |
| Bis-A epoxy (YL980U) | 4.84 |
| Bis-F epoxy (YL983U) | 14.81 |
| Epon 161 | 5.63 |
| Epon 165 | 2.81 |
| PKHH | 23.76 |

Epoxy Composition 4

| | Parts |
|---|---|
| Ingredient | (dry) |
| Bis-F epoxy (YL983U) | 12.88 |
| Epon 161 | 6.10 |
| Epon 165 | 3.05 |
| PKHH | 25.76 |

Epoxy Composition 5

| | Parts |
|---|---|
| Ingredient | (dry) |
| Bis-F epoxy (YL983U) | 12.50 |
| Epon1009F | 6.00 |
| PKHH | 25.00 |

Epoxy Composition 6

| | Parts |
|---|---|
| Ingredient | (dry) |
| Bis-A epoxy (YL980U) | 6.00 |
| Bis-F epoxy (YL983U) | 7.60 |
| Epon 161 | 6.40 |
| Epon 165 | 3.30 |
| PKHH | 19.20 |

Epoxy Composition 7

| | Parts |
|---|---|
| Ingredient | (dry) |
| Bis-F epoxy | 8.00 |
| Epon 161 | 5.00 |
| Epon 165 | 3.00 |
| PKFE | 31.00 |

Epoxy Composition 8

| | Parts |
|---|---|
| Ingredient | (dry) |
| Glycerol triglycidyl ether | 4.0 |
| PKFE | 33.0 |

Epoxy Composition 9

| | Parts |
|---|---|
| Ingredient | (dry) |
| Bis-F epoxy (YL983U) | 2.0 |
| Glycerol triglycidyl ether | 3.2 |
| Epalloy 8330 | 1.2 |
| PKFE | 33.0 |

The latent hardeners include controlled release-able or trigger-able curing agents or accelerators. Examples of curing agents or accelerators typically used in epoxy adhesives or molding compounds include polyamide-polyamine-based compounds, aromatic polyamine compounds, imidazole compounds, imidazole-epoxide adducts, tetrahydrophthalic anhydride and the like. The accelerator or curing agent may be liquid or solid. Preferred liquid accelerators include, e.g., amine compounds, imidazole compounds and mixtures thereof. Exemplary liquid accelerator compounds include 1-(2-hydroxyethyl)imidazole, 2-methylimidazole, 2-ethyl-4-methylimidazole, 1-benzyl-2-methylimidizole, 1-cyanoethyl-2-phenyl-4, 5-dihydroxymethyl imidazole, 1-(2-hydroxyethyl)imidazole, 2-ethyl-4-methylimidazole, phenylimidazole, 2-phenyl-4-methylimidazole, 1-cyanoethyl-2-phenylimidazole, multifunctional mercaptans (e.g., Anchor 2031), and stannous octate. Preferred solid accelerators include, e.g., urea, 2-phenyl-4,5-dihydroxymethyl imidazole, and 1-(2-hydroxyethyl)imidazole. Other examples of curing agents include dicyanodiamide (DICY), adipic dihydrazide, amines such as ethylene diamine, diethylene triamine, triethylene tetraamine, BF3 amine adduct, Amicure from Ajinomoto Co., Inc, sulfonium salts such as diaminodiphenylsulphone, p-hydroxyphenyl benzyl methyl, and sulphonium hexafluoroantimonate. For shelf stability in applications that require high speed curing at low temperature curing catalysts/accelerators may optionally be absorbed in a molecular sieve or in the form of microcapsules to enhance the curing processes as disclosed in Japanese Patent Publication No. 17654/68, 64/70523, U.S. Pat. Nos. 4,833,226, 5,001,542, 6,936,644.

In the case of microencapsulated accelerators or curing agents, the microcapsules must be first broken or rendered permeable by pressure, shear, heat or combinations of above methods in order to cure the epoxy resin. Examples of commercially available imidazole microcapsules include the Novacure series from Asahi Chemical Industry Co., Ltd. such as HX 3721 (2-methyl imidazole). The microcapsules may be formed by a polymer shell. In certain embodiments they are formed by a polyurethane or a polyurea shell. The preferable concentration range of the latent catalyst/curing agent is from about 0.05% by weight to about 50% by weight, more preferably from about 2% by weight to about 40% by weight based on the adhesive composition. In the case when a microencapsulated latent curing agent such as Novacure imidazole microcapsule is used, the more preferable concentration range is from about 5% by weight to about 40% by weight and still more particularly about 25 to 40% by weight based on the adhesive composition. Novacure latent hardeners from Asahi Kasei are microcapsules of hardeners dispersed in low Mw epoxides. In one embodiment, imidazoles and their epoxide adducts are typical core materials used in the latent hardeners and, in a more particular embodiment they are encapsulated by a polymer shell such as a polyurethane or polyurea shell and in a more particular embodiment the microcapsules may be prepared by interfacial polymerization/crosslinking reactions. The core materials may be released by heat or a solvent that may swell or plasticize the shell polymer to trigger the crosslinking or polymerization of epoxides in the adhesives/coatings.

To further improve the curing characteristics, in one embodiment, a group of secondary co-catalyst or co-curing agent is also disclosed. As disclosed in Published Application 2008/0090943, it was found that significant improvements in reaction kinetics could be achieved by incorporating in the epoxy composition about 0.01% to about 8%, more preferably about 0.05% to 5%, by weight of a secondary co-catalyst or co-curing agent selected from a group consisting of ureas, urethanes, biurets, allophanates, amides and lactams comprising a N N,N-dialkylamino, N,N-diarylamino, N-alkyl-N-aryl-amino or a dicycloalkylamino functional group. Useful examples include amide such as N-(3-(dimethyamino)propyl)lauramide, lactams such as 1,2-benzisothiazol-3(2H)-one, and benzothiazols such as 2-(2-benzothiazolylthio)ethanol. To further improve the connection reliability and consistency of the curing kinetics, less diffusive derivatives, dimers or oligomers of the above mentioned co-catalysts have been found particularly useful. Not to be bound by the theory, it was believed that the increasing molecular weight or improving its compatibility with the epoxide resin can effectively reduce the mobility of the co-catalyst to migrate out of the adhesive film during aging and resulted in a better environmental stability.

U.S. Published Application 2008/0090943 discloses that leuco dyes, particularly those comprising a N,N-dialkylamino, N,N-diarylamino, N-alkyl-N-aryl-amino, N-alkylamino, or N-arylamino functional group on at least one of their aromatic rings, function as very effective co-catalysts or co-accelerators to improve the curing characteristics of epoxy resins. More specifically, it discloses adhesive compositions comprising a leuco dye and a latent curing agent such as Novacure imidazole capsules. The leuco dyes have shown significant improvement in curing and conversion of the epoxides while maintaining acceptable shelf-life stability. The concentration of the leuco dye used is from about 0.05% by weight to about 15% by weight, preferably from about 0.5% by weight to about 5% by weight based on the total weight of the adhesive composition.

Suitable cocatalysts of the present invention include, but are not limited to, triarylmethane lactones, triarylmethane lactams, triarymethane sultones, fluorans, phthalides, azaphthalides, spiropyrans, spirofluorene phthalides, spirobenzantharacene phthalides. Leuco dyes comprising a N,N-dialkylamino, N,N-diarylamino, N,N-dialkylaryl or N-alkyl-N-aryl-amino, N-alkylamino, or N-arylamino group on the aromatic ring are particularly useful.

In one embodiment, the acrylic block copolymers can be diblock (A-B), triblock (A-B-A) or a multiblock (A-(B-A)n) where n is from 2 to 8 block copolymers that include a flexible elastomeric midblock. In accordance with one embodiment, the flexible (B) midblock is a poly alkyl (meth)acrylate wherein the alkyl group contains about 2 to 8 carbon atoms such as polybutyl acrylate, polyethyl acrylate, poly 2-ethylhexyl acrylate, poly(2-ethylhexyl)methacrylate and poly(isooctyl acrylate). Polyether polyurethanes are also useful as flexible blocks. In another embodiment the flexible mid block is a carboxyl terminated butadiene acrylonitrile (CTBN) rubber. In still another embodiment, the block copolymer is one in which a poly(butyl acrylate) is positioned between two poly(methyl methacrylate) end blocks. Acrylic block copolymers such as MAM Nanostrength® block copolymers terminated in PMMA end blocks available from Arkema Corporation, particularly (PMMA-PBuA-PMMA) block copolymers such as M51, M52, and M53 and their functionalized derivatives such as M52N may be used as dispersants to prepare a stable dispersion of high molecular weight (Mw) phenoxy resins in a common weak coating solvents or diluents of low polarity or dielectric constant having a solubility parameter of less than 9.5 or even less than about 9.0 and more particularly about 8.0 to 9.4 and still more particularly about 8.2 to 9.2, such as ethyl acetate EtOAc (9.2), i-PrOAc (8.4), BuOAc (8.5), MIBK (8.4), MIPK (8.5), toluene (8.9), xylene (8.85), ethylbenzene (8.7) which provide good dispersibility of the epoxy resins in the presence of the dispersants and yet do not attack the capsule shell of the latent hardener. It has been shown that the use of such a block copolymer result in a stable dispersion of the epoxy resin compositions comprising a phenoxy resin such as PKFE, PKHH, PKHB . . . etc. A coating fluid stability of more than several days with an excellent process-ability may be achieved and coatings of high film integrity and coating quality as well as a long shelf-life stability are obtained. A shelf-life stability of more than 6 months at room temperature has been demonstrated with an adhesive composition dispersed in a mixture of EtOAc/i-PrOAc using about 3-8% of M52N Nanostrength ® resin as the dispersing agent for the adhesive composition. In contrast, a good solvent for the phenoxy resins is needed to assure a good coating quality in the absence of such a polymeric dispersant. Typical good solvents for the same composition include, but are not limited to, DMSO, NMP, MEK, acetone, THF, alkoxyethers and cyclohexanone or their mixtures with a second good solvent or diluent. Those good or strong solvents for the phenoxy resins are often hostile solvents for the latent hardeners. They tend to plasticize or soften the shell and reduce the barrier properties of the latent hardeners. In some cases, they are also goof solvents for the core materials or the hardeners therein. The use of such solvents may also create a high osmotic pressure across the shell and, in turn, reduce the shelf life stability of the latent hardeners. It has been found that without the block copolymer dispersion agent, the epoxy composition has to be prepared in at least a strong solvent for the phenoxy resins and the resultant adhesive coatings are either of poorer coating quality or of poorer shelf-life stability.

In addition to being defined by its solubility constant, the weak solvents or diluents of the compositions comprising a phenoxy resin may also be defined by their dielectric constant, although the correlation may not be so direct as the solubility parameter mentioned above. In accordance with one embodiment the weak solvents or diluents used in the adhesive composition have a dielectric constant of about 2 to 8. In another embodiment, the weak solvents or diluent are characterized by a dielectric constant of about 2.2 to 6.5.

In another embodiment, the composition contains an LPA that is miscible with the epoxy resin and separates to form stress-absorbing nodules upon curing. The LPA is not necessarily a block copolymer. Examples of copolymers that may be effective as LPAs and/or block copolymer dispersants include those shown in the following table:

| | | EEW |
|---|---|---|
| | Description | (g/eq) |
| Epon 58003 | An elastomer modified epoxy functional | 285-330 |
| (Hexion | adduct of a bisphenol-F epoxy resin and | |
| Specialty | a carboxy-terminated butadiene-acrylonitrile | |
| Chemicals) | (CTBN) rubber. Elastomer content 40%. | |
| Epon 58005 | An elastomer modified epoxy functional | 325-375 |
| (Hexion | adduct of bisphenol A epoxy resin and a | |
| Specialty | carboxyl terminated butadiene-acrylonitrile | |
| Chemicals) | (CTBN) elastomer. Elastomer content 40%. | |
| Epon 58034 | An elastomer modified epoxy functional | 275-305 |
| (Hexion | adduct formed from the reaction of | |
| Specialty | HELOXY ™ 68 Modifier and a carboxyl | |
| Chemicals) | terminated butadiene-acrylonitrile elastomer. | |
| | HELOXY ™ Modifier 68 is a diglycidyl | |
| | ether of neopentyl glycol. Elastomer content | |
| | is approximately 50 percent by weight. | |
| HyPox RK84 | Adduct of solid diglycidyl ether of | 1200-1800 |
| (CVC | Bisphenol A and a CTBN rubber. Elastomer | |
| Thermoset | content 55%. | |
| Specialties) | | |
| HyPox RK84L | Adduct of solid diglycidyl ether of | 1250-1500 |
| (CVC | Bisphenol A and a CTBN rubber. Elastomer | |
| Thermoset | content 55%. | |
| Specialties) | | |
| HyPox UA10 | A standard Bisphenol A epoxy resin which | 210-220 |
| (CVC | has been modified with a select | |
| Thermoset | thermoplastic polyurethane (TPU). | |
| Specialties) | Elastomer content 12%. | |
| HyPox UA11 | A standard Bisphenol A epoxy resin system | 210-220 |
| (CVC | which has been modified with a select | |
| Thermoset | thermoplastic polyurethane (TPU). Urethane | |
| Specialties) | polymer content 5%. | |
| M51 | A symmetric MAM copolymer with two | — |
| (Arkema, Inc.) | poly(methyl methacrylate) blocks | |
| | surrounding a center block of poly(butyl | |
| | acrylate). Low MW, lowest viscosity. | |
| M52 | A symmetric MAM copolymer with two | — |
| (Arkema, Inc.) | poly(methyl methacrylate) blocks | |
| | surrounding a center block of poly(butyl | |
| | acrylate). Low MW, lowest viscosity. | |
| | Medium MW, low viscosity. | |
| M53 | A symmetric MAM copolymer with two | — |
| (Arkema, Inc.) | poly(methyl methacrylate) blocks | |
| | surrounding a center block of poly(butyl | |
| | acrylate). High MW, best toughening with | |
| | PMMA friendly crosslinking agents (e.g., | |
| | Jeffamine, MDEA) | |
| M52N | A symmetric MAM copolymer with two | — |
| (Arkema, Inc.) | poly(methyl methacrylate) blocks | |
| | surrounding a center block of poly(butyl | |
| | acrylate). Functionalized MAM, best | |
| | toughening with PMMA unfriendly | |
| | crosslinking agents (e.g., DICY, DDS). | |

One example of a rigid polymer block is poly (methyl methacrylate). In addition to being rigid, this block is also compatible with the epoxy resin, such that the LPA can be mixed with the uncured resin without phase separation when the LPA is used in amounts effective to prevent shrinkage. In accordance with one embodiment, the (A) and (B) blocks of the LPA are selected such that the LPA and the epoxy resin form a homogeneous solution when the LPA is used in amounts up to 15% by weight. M52N from Arkema, Inc. is a particularly useful LPA.

In another embodiment, the LPA is not necessarily a block copolymer, but a polymer that is miscible with the epoxy resin and separates to form stress-absorbing nodules upon curing. Other examples of LPAs are conjugated dienes having about 4 to 12 carbon atoms with polybutadiene and polyisoprene being two representative examples, provided they are compatible with the epoxy resin. In accordance with one modification, the compatibility of the LPA in the epoxy adhesive can be enhanced by epoxidizing the block copolymer as described in U.S. Pat. No. 5,428,105. For example, if the LPA copolymer includes unsaturated groups such as an unsaturated diene, a portion of these groups (e.g., about 1 to 15%) can be oxidized. In still another embodiment, the LPA may be a core-shell polymer obtained by emulsion or dispersion polymerization. Examples of such core-shell rubbers include, but are not limited to, acrylic core-shell rubber such as Paraloid™ EXL-2335 from Dow Chemical.

The LPA may be used in amounts up to about 15% by weight based on the combined weight of the LPA and the epoxy resin. The LPA is more typically used in an amount of about 4 to 10% and in one embodiment it is used in an amount of about 7%. The amount of the LPA is adjusted to provide the required peeling strength.

The molecular weight (Mw) of the LPA may be about 15,000 to 200,000 and more typically about 50,000 to 100,000. In one embodiment, the molecular weight (Mw) is about 88,000. In one embodiment, the LPA contains about 5 to 50% of the flexible (B) block.

The LPA when mixed with the uncured epoxy resin forms a homogenous single phase. As the epoxy resin cures, the epoxy resin network is formed which phase separates from the initial solution and forms spherical nodules of the LPA. This is called “reaction induced phase separation.” The size of the stress absorbing nodules will vary with the amount of LPA used, the Mw of the LPA and the interaction between the epoxy resin and the LPA. In certain embodiments, ultimately a network is formed wherein the LPA nodules are connected to adjacent nodules by a polymer link. As the epoxy resin cures and begins to shrink, cracking is prevented because the stresses are transferred to the nodular LPA phase which is flexible. The disclosed block copolymers have been found to be particularly effective.

The acrylic block copolymers such as M52N are dispersants for the phenoxy binders in weak solvents or diluents such as propyl acetate, i-propyl acetate, butyl acetate, toluene . . . etc. which are good solvents for epoxide monomers, dimers or other multifunctional epoxides, but are poor solvents for the binder and do not attack the latent hardeners thereby providing a long shelf-life in such weak solvents or diluents. It has been shown that the use of such block copolymers result in a coating of great film integrity and coating quality as well as a very long shelf-life stability. A shelf-life stability of more than 6 months at room temperature has been demonstrated with an adhesive composition dispersed in a mixture of EtOAc/i-PrOAc using about 3-8% of Nanostrength® block coplymer resin as the dispersing agent for the adhesive composition. In some of the specific embodiments showing long shelf life stability and excellent coating quality, Nanostrength® M52N and PKFE were used as the dispersant and binder, respectively, in the adhesive composition dispersed in a solvent mixture consisting of from about 60/40 to about 40/60 of EtOAc/i-PrOAc. The weight ratio of M52N/PKFE was about from 1/4 to 1/12, preferably from 1/6 to 1/10. The total % of solid of the coating fluid is typically from 20 to 40%, preferably from 25 to 35% depending on the composition. The concentration of the latent hardener in the dried coating is typically from about 10 to 80% by weight, preferably from 20 to 60% by weight. Without the use of M52N as the dispersant, the coating fluid tended to be unstable and in some cases, even phase separated during the coating process and resulted in a poor coating quality. In contrast, the coating of the same composition prepared in a stronger solvent such as MEK, acetone, THF, NMP and cyclohexanone or their mixtures having a solubility parameter close to that of phenoxy resins is either of poor coating quality or of poor shelf-life stability.

The epoxy adhesive may comprise a filler or additive to control one or more properties of the epoxy adhesive such as rheology, wetting and moisture resistance. A particulate rheology modifier may be added to the epoxy adhesive. The rheology modifier may be a thixotropic agent having an average particle size between about 0.001 and about 10 microns, and more preferably between about 0.01 and about 5 microns. Examples of particulate rheology modifiers include barium sulfate, talc, aluminum oxide, antimony oxide, kaolin, finely divided silicon dioxide which may be colloidal or rendered hydrophobic, micronized talcum, micronized mica, clay, kaolin, aluminum oxide, aluminum hydroxide, calcium silicate, aluminum silicate, magnesium carbonate, calcium carbonate, zirconium silicate, porcelain powder, glass powder, antimony trioxide, titanium dioxide, barium titanate, barium sulfate and mixtures thereof. One particularly preferred rheology modifier is fumed silica such as Cab-O-Sil M-5 and hydrophobic silica such as TS530, TS610 and TS720 from Cabot Corp., MA.

To improve the ability of the epoxy adhesive to wet a surface a wetting agent may be added. Exemplary wetting agents include surfactants such as epoxy silanes, branch or block copolymers of siloxanes, fluoro-surfactants and hydrocarbon-type surfactants. Suitable surfactants include FC4430 (formally referred to as FC-430) which is available from 3M Corp. of St. Paul Minn., Silwet series surfactants such as Silwet L7622 and L7608 from GE Silicones-OSi Specialties, BYK 322, BYK325 and BYK 631N from BYK-Chemie. The Silwet surfactants are often used in an amount of about 0.05 to 1% by weight, preferably 0.1 to 0.5% by weight.

The moisture resistance or wet adhesion of the cured compound may be improved by including a coupling agent in the epoxy adhesive. Typical coupling agents include organic metal compounds that comprise chromium, silane, titanium, aluminum and zirconium. The most commonly used coupling agents comprise silane such as vinyl-triethoxysilane, vinyltris(2-methoxyethoxy)silane, 3-methacryloxypropyltrimethoxysilane, 3-glycidoxypropyltrimethoxysilane (e.g., Silquest 187® from Crompton), 2-(3,4-epoxycyclohexyl)ethyltrimethoxy silane, N-2-(aminoethyl)-3-aminopropylmethyldimethoxy-silane, 3-aminopropyltriethoxysilane, and 3-chloro-propyltrimethoxy-silane. If present, the coupling agent frequently comprises less than about 5% by weight, preferably less than 3% by weight of the epoxy adhesive.

For prepreg, filament winding and molding compound applications, reinforcement fibers such as glass fiber and carbon fiber are often included in the composition. Natural fibers such as bamboo fibers, wood and other cellulose fibers are also useful. They may be in a pellet form prepared by extrusion followed by cutting or in a sheet form prepared by coating, lamination or impregnation.

The epoxy compositions of this invention may be applied in a conductive coating or adhesive layer or layers, the conductive particles either in the random or non-random arrays may be in the adhesive layer, on the adhesive layer or underneath the adhesive layer. Flexible configurations may be conveniently arranged according to particular application requirements. These configurations may include an arrangement where the adhesive that comprises the improved epoxy compositions of this invention and the conductive particles are disposed in separate, adjacent or non-adjacent layer in an ACF of either a random or non-random particle array. In one embodiment the conductive particles may be mixed with the adhesive composition before forming a film. In another embodiment, the adhesive may be coated first without the conductive particles and the conductive particles applied to the adhesive by a particle transfer process.

In one embodiment a ACF adhesive coating composition comprises about 100 to 300 parts of a coating solvent or solvent mixture, about 20-50 parts of a phenoxy resin such as PKFE, about 2 to 9 parts of the block copolymer dispersion agent such as M52N, about 20 to 70 parts of a latent hardener such as Novacure HXA3922 and HX3721, and about 0 to 20 parts of a multifunctional epoxide or a mixture of epoxides selected from a group comprising bisphenol F diglycidyl ether and glycerol triglycidyl ether, Epon 161, Epon 165, and Epalloy 8330 etc. In one embodiment, a combination of of M52N and PKFE is used in a weight ratio of M52N/PKFE of about 1/5 to 1/10, preferably from about 1/6 to 1/9. To achieve an acceptable shelf-life stability of the dried adhesive/coating, the coating solvent is selected so that it does not (to a commercially adverse degree) attack or soften the shell of the latent hardener during the entire coating process including compounding, fluid delivery, coating, drying and converting. The composition was then mixed with 3 to 20 parts of conductive particles and coated on a release substrate. In one embodiment, to produce the fixed array ACF, the adhesive composition is first coated on a release substrate. A fixed array of particles is then transferred to the adhesive layer from a microcavity film prefilled with conductive particles.

Suitable materials for the web of an ACF include, but are not limited to polyesters such as poly ethylene terephthalate (PET) and polyethylene naphthalate (PEN), polycarbonate, polyamides, polyacrylates, polysulfone, polyethers, polyimides, and liquid crystalline polymers and their blends, composites, laminates or sandwich films. The improved ACF is disclosed in another co-pending patent application Ser. No. 11/418,414 entitled “Non-random Array of An-isotropic Conductive Film (ACF) and Manufacturing Processes”. The disclosures made in that patent application are hereby incorporated by reference in this patent application.

It is evident that the present invention provides an epoxy composition with improved curing characteristics for high speed, automatic electronic packaging or device connection applications such as bonding with an ACF. The invention is illustrated in more detail below by reference to the following non-limiting examples wherein unless otherwise limited, all parts are by weight.

The adhesive compositions can be prepared by dissolving the solid epoxy components in a 1/1 by volume EtOAc/i-PrOAc mixture to prepare stock solutions of each ingredient. The low molecular weight or low percentage components are mixed and vigorously blended together. Dispersions of the rheology modifier in the EtOAc/i-PrOAc mixture are prepared and added to the coating composition followed by addition of the high Mw components and surfactants. Before coating, the hardener is dispersed in i-PrOAc and added to the coating with agitation (5 min.) and continuous stirring rotation (0.5 hr.). The coating composition is filtered through an 11μ filter and then degassed by ultrasound for 5 min. The ingredients useful in one embodiment are identified in the following table.

Ingredient

| | | |
|---|---|---|
| Bis-A epoxy (YL980U) | Bisphenol A | |
| | epoxy resin | |
| Bis-F epoxy (YL983U) | Bisphenol F | |
| | epoxy resin | |
| Epon 161 | Epoxy resin | Hexion Specialty |
| | | Chemicals |
| Epon 165 | Epoxy resin | Hexion Specialty |
| | | Chemicals |
| Epon 58003 | See Table 1 | Hexion Specialty |
| | | Chemicals |
| HyPox UA11 | See Table 1 | CVC Thermoset |
| | | Specialties |
| Milled Cab-O-Sil M5 | Fumed silica | Cabot Corp. |
| Milled nanoAlN | | |
| PKHH | Phenoxy resin | Phenoxy Specialties |
| Novacure HX 3721, | Encapsulate 2-methyl | Asahi Chemical Ind. |
| HXA3922 | imidazole | |
| Silwet 7622 & 7608 | Organosilicone | Setre Chemical Co. |
| | Surfactant | |
| Silquest 187 | Gammaglycidoxyproply- | Crompton |
| | trimethoxysilane | |

The following formulations are examples of particularly effective adhesive compositions:

### EXAMPLE 1

| | parts in |
|---|---|
| | dried |
| Ingredient | film |
| Bis-A epoxy (YL980U) | 3.9 |
| Bis-F epoxy (YL983U) | 3.5 |
| Epon 161 | 4.4 |
| Epon 165 | 2.8 |
| M52N | 8.6 |
| milled M5 | 0.7 |
| milled nanoA1N | 3.7 |
| PKHH | 34.7 |
| co-catalysts Magenta 20 | 0.50 |
| Novacure HX 3721 | 35.6 |
| Silwet 7622 | 0.4 |
| Silquest 187 | 1.2 |
| Total | 100.0 |

### EXAMPLE 2

| | Parts |
|---|---|
| Ingredient | (dry) |
| Bis-F epoxy | 8.00 |
| Epon 161 | 5.00 |
| Epon 165 | 3.00 |
| M52N | 6.03 |
| PKFE | 31.00 |
| PKCP-80 | 5.87 |
| Silwet L7608 | 0.40 |
| Silquest A-187 ® | 1.00 |
| Magenta20 | 0.50 |
| Novacure HX 3721 | 34.60 |
| Total | 100.00 |

### EXAMPLE 3

| | parts in |
|---|---|
| | dried |
| Ingredient | film |
| Glycerol triglycidyl ether | 4.0 |
| PKFE | 32.7 |
| M52N | 4.0 |
| Paraloid ™ EXL-2335 | 4.7 |
| TiO₂ (Du Pont) | 1.0 |
| Cabot silica TS-530 | 0.3 |
| Cabot silica TS-720 | 0.6 |
| Novacure HXA 3922 | 52.0 |
| Silwet 7622 | 0.2 |
| Silquest A187 | 0.5 |
| Total | 100.0 |

Having described the invention in detail and by reference to specific embodiments thereof it will be apparent that numerous variations and modifications are possible without departing from the spirit and scope of the following claims.

What is claimed is:

1. An adhesive coating composition comprising: (i) a phenoxy resin, (ii) a latent hardener, (iii) a multifunctional epoxide, (iv) an acrylic block co-polymer, and (v) a weak solvent having a solubility parameter less than 9.5, the acrylic block co-polymer dispersing the phenoxy resin in the weak solvent.

2. The composition of claim 1 wherein the phenoxy resin is a linear polymer of bisphenol A diglycidyl ether, and the block copolymer has a first flexible block and a second rigid block that makes the copolymer compatible with the uncured phenoxy resin, wherein a mixture of the phenoxy resin and the block copolymer forms a dispersion of the phenoxy resin in the weak solvent, the solvent having a solubility parameter less than about 9.0.

3. The composition of claim 2 wherein the rigid block is polymethyl methacrylate.

4. The composition of claim 3 wherein the flexible block is formed from a poly(alkyl acrylate) wherein the alkyl group has about 2 to 8 carbon atoms.

5. The composition of claim 4 wherein the flexible block is formed from poly(butyl acrylate).

6. The composition of claim 5 wherein the block copolymer is a triblock copolymer terminating in polymethyl methacrylate blocks.

7. The composition of claim 2 wherein the latent hardener is a microencapsulated curing agent.

8. The composition of claim 7 wherein the latent hardener is an encapsulated imidazole.

9. The composition of claim 7 wherein the block copolymer is present in an amount up to about 15% by weight.

10. The composition of claim 9 wherein the weak solvent is selected from the group consisting of as EtOAc, PrOAc, i-PrOAc, BuOAc, sec-BuOAc, MIPK, MIBK, toluene, xylene, ethylbenzene and mixtures thereof.

11. The composition of claim 10 wherein the phenoxy resin is present in the dry composition in an amount of about 20 to 50 parts by weight, the latent hardener is present in an amount of about 20 to 70 parts by weight, and the block copolymer is present in the adhesive composition in amount of about 4 to 10% based on the total dry weight of the composition.

12. The composition of claim 11 wherein the weight ratio of the block copolymer to phenoxy resin is from 1/4 to 1/12.

13. The composition of claim 11 wherein the weight ratio of the block copolymer to phenoxy resin is from 1/6 to 1/10.

14. A film useful in providing an anisotropic conductive film comprising a plurality of conductive particles and a dried adhesive film prepared from a coating composition comprising: (i) a phenoxy resin, (ii) a latent hardener, (iii) a multifunctional epoxide, (iv) an acrylic block co-polymer, and (v) a weak solvent having a solubility parameter less than 9.5, the acrylic block co-polymer dispersing the phenoxy resin in the weak solvent before the film is dried.

15. The film of claim 14 wherein the phenoxy resin is a linear polymer of bisphenol A diglycidyl ether, and the block copolymer has a first flexible block and a second rigid block that makes the copolymer compatible with the uncured phenoxy resin, wherein prior to drying a mixture of the phenoxy resin and the block copolymer forms a dispersion of the phenoxy resin in the weak solvent, the solvent having a solubility parameter less than about 9.0.

16. The film of claim 15 wherein the flexible block is formed from poly(butyl acrylate).

17. The film of claim 16 wherein the block copolymer is a triblock including blocks of poly(methyl methacrylate) on each end of a poly(butyl acrylate) block.

18. The composition of claim 17 wherein the weak solvent is selected from the group consisting of as EtOAc, PrOAc, i-PrOAc, BuOAc, sec-BuOAc, MIPK, MIBK, toluene, xylene, ethylbenzene and mixtures thereof.

19. An electronic device having an anisotropic conductive film formed from a film comprising a plurality of conductive particles and a dried adhesive film prepared from a coating composition comprising: (i) a phenoxy resin; (ii) a latent hardener; (iii) an acrylic block co-polymer, and (iv) a weak solvent having a solubility parameter less than 9.5, the acrylic block co-polymer dispersing the phenoxy resin in the weak solvent prior to being dried to form the dried adhesive film.

20. The electronic device of claim 19 wherein the phenoxy resin is a linear polymer of bisphenol A diglycidyl ether, and the block copolymer has a first flexible block and a second rigid block that makes the copolymer compatible with the uncured phenoxy resin, wherein a mixture of the phenoxy resin and the block copolymer forms a dispersion of the phenoxy resin in the weak solvent, the solvent having a solubility parameter less than about 9.0 .

21. The device of claim 20 wherein the flexible block is formed from poly(butyl acrylate).

22. The device of claim 21 wherein the block copolymer is a triblock including blocks of poly(methyl methacrylate) on each end of a poly(butyl acrylate) block.

23. A dried adhesive film prepared from a coating composition including: (i) a phenoxy resin, (ii) a latent hardener, (iii) a multifunctional epoxide, (iv) an acrylic block co-polymer, and (v) a weak solvent having a solubility parameter less than 9.5, the acrylic block co-polymer dispersing the phenoxy resin in the weak solvent prior to the film being dried.

24. The film of claim 23 wherein the phenoxy resin is a linear polymer of bisphenol A diglycidyl ether, and the block copolymer has a first flexible block and a second rigid block that makes the copolymer compatible with the uncured phenoxy resin, wherein prior to drying a mixture of the phenoxy resin and the block copolymer forms a dispersion of the phenoxy resin in the weak solvent, the solvent having a solubility parameter less than about 9.0.

25. The film of claim 24 wherein the flexible block is formed from poly(butyl acrylate).

26. The film of claim 25 wherein the block copolymer is a triblock including blocks of poly(methyl methacrylate) on each end of a poly(butyl acrylate) block.

27. The composition of claim 26 wherein the weak solvent is selected from the group consisting of as EtOAc, PrOAc, i-PrOAc, BuOAc, sec-BuOAc, MIPK, MIBK, toluene, xylene, ethylbenzene and mixtures thereof.
